(19) United States
(12) Patent Application Publication
(10) Pub. No.: US 2014/0346111 A1
(43) Pub. Date: Nov. 27, 2014

(54) SEAWATER TREATMENT METHOD

(71) Applicant: KURITA WATER INDUSTRIES LTD., Nakano-ku, Tokyo (JP)

(72) Inventors: Yasuhiro Oi, Nakano-ku (JP); Tomoya Iuchi, Nakano-ku (JP)

(73) Assignee: KURITA WATER INDUSTRIES LTD., Nakano-ku, Tokyo (JP)

(21) Appl. No.: 14/368,447

(22) PCT Filed: Dec. 25, 2012
(86) PCT No.: PCT/JP2012/083454

§ 371 Date: Jun. 24, 2014

(30) Foreign Application Priority Data
Dec. 28, 2011 (JP) 2011-287580

(51) Int. Cl. C02F 1/52; C02F 1/56; C02F 1/44

(52) U.S. Cl. CPC C02F 1/5245; C02F 1/441; C02F 1/56; C02F 2103/08
USPC 210/639; 210/727

(57) ABSTRACT

In a seawater treatment method in which after seawater is coagulated by a coagulant and is processed by a solid-liquid separation treatment, an RO treatment is performed, RO feed water having a good water quality is obtained by a small addition amount of the coagulant, and by the RO treatment of the RO feed water, a stable RO treatment can be performed over a long period of time. In a seawater treatment method which is a pretreatment method performed prior to a membrane separation treatment of seawater, after a cationic organic flocculant and/or an inorganic coagulant is added to seawater to conduct a reaction, a coagulation treatment is performed by addition of an alkaline solution of a high molecular weight compound which has a phenolic hydroxide and which is insolubilized under a high salt concentration, and a solid-liquid separation treatment is then performed. Subsequently, this treated water is desalinated by a membrane separation treatment.

### FIELD OF INVENTION

The present invention relates to a pretreatment method performed prior to a membrane separation treatment of seawater and in particular, relates to a method for performing a coagulation treatment and a solid-liquid separation treatment of seawater. In addition, the present invention also relates to a membrane separation treatment method following the above treatment and in particular, relates to a preferable method for a seawater desalination treatment.

### BACKGROUND OF INVENTION

Seawater desalination by a reverse osmosis (RO) membrane separation treatment has been widely performed not only in Middle East where freshwater is difficult to obtain but also, in recent years, in Mainland China, Australia, and the like.

Prior to the membrane separation treatment, a pretreatment is performed to remove fouling components in seawater, such as fine clay components and/or high molecular weight organic substances (biopolymers) derived from biological metabolism, which adhere to an RO membrane and decrease a flux passing therethrough. For this pretreatment, a coagulation/solid-liquid separation treatment using a ferric chloride solution has been widely carried out. As the amount of ferric chloride to be added in the form of Fe, 0.5 to 1 mg/L (concentration of the ferric chloride solution: 38 wt/wt %, Fe: 13.1%, 40-degree Baume conversion: 3.8 to 7.6 mg/L) is regarded as the standard.

For the evaluation of the removal effect (membrane fouling index) of fouling components by the coagulation/solid-liquid separation treatment, SDI (Silt density index, the content being the same as that of FI (fouling index) defined by JIS K 3802) defined by ASTM D4189 has been used. An SDI value required for feed water used for membrane separation is set to 4.0 or less and preferably 3.0 or less.

Incidentally, as the index of a membrane filtration property (membrane fouling property) of water (membrane feed water) to be processed by a membrane separation treatment, an “MFF value” has been used. A method for measuring this MFF value is as described below.

(1) By a coagulation treatment using a jar tester, 1,000 ml or more of coagulation treated water is prepared.

(2) The coagulation treated water is left still for 30 minutes to precipitate coagulated flocks.

(3) The coagulation treated water of the above (2) is gradually filtered from a supernatant thereof with No. 5A (5-μm pore size) filter paper, and the total coagulation treated water including the coagulated flocks is finally filtered.

(4) An obtained filtrate in an amount of 1,000 ml or more is equally (500 ml each) divided into two measuring cylinders.

(5) By using a nitrocellulose-made membrane filter having a pore diameter of 0.45 μm and a diameter of 47 mm, 500 ml in the first measuring cylinder is filtered under a reduced pressure of 66 kPa (500 mm Hg), and a time T1 required for this filtration is measured. Subsequently, 500 ml in the other measuring cylinder is filtered under a reduced pressure in a manner similar to that described above, and a time T2 required for this filtration is measured.

(6) The MFF value is calculated by the following formula.

MFF=T2/T1

According to the results of the test carried out by the present inventors, in an MFF range of 1.01 to 1.15, for example, as shown in FIG. 1, a linear function is present between the MFF value and the SDI value. As described above, the SDI value of RO feed water to be supplied to a reverse osmosis membrane apparatus (RO apparatus) for a seawater desalination treatment is set to preferably 4.0 or less and particularly preferably 3.0 or less, and as the MFF value, 1.094 or less is preferable, and 1.060 or less is particularly preferable.

In addition, in recent years, for example, because of flow of domestic wastewater into seawater, and propagation of microorganisms, such as algae, caused thereby, the concentration of microbiological metabolic products (biopolymers) in seawater is occasionally increased. A phenomenon of membrane fouling caused by the biopolymer production as described above is particularly liable to occur in closed water areas, such as Arabian Bay and Red Sea in Middle East and Bo Hai Bay in Mainland China.

The biopolymers are main membrane fouling substances, and the propagation thereof increases (degrades) the membrane filtration index SDI, and in order to achieve an SDI of 4.0 or less, the amount of ferric chloride to be added is necessarily increased.

On the other hand, in consideration of restriction on disposal of sludge generated during coagulation to oceans, and the like, it has been requested to decrease the addition amount of a ferric chloride solution as small as possible or to zero, if possible, so as to obtain coagulation pretreated water having a targeted membrane filtration index with a significantly small amount of a coagulant chemical.

In order to reply the request of decreasing the addition amount of ferric chloride, although an attempt in which a cationic high molecular weight flocculant, such as a polyalkylene polyamine, is used together with ferric chloride has been tried, an effect of sufficiently decreasing the SDI has not been obtained.

Patent Literature 1 discloses a method in which after an alkaline solution of a phenolic high molecular weight compound is added to seawater, a coagulation treatment is performed therefor by addition of an inorganic coagulant, solid-liquid separation is then performed on the coagulation treated water, and the separation treated water is finally processed by a reverse osmosis membrane treatment. According to the method disclosed in Patent Literature 1, MFF and SDI of RO feed water are improved, and hence, stable operation of an RO apparatus can be performed over a long period of time. However, in the method disclosed in Patent Literature 1, the addition amount of the inorganic coagulant is large, and as a result, there has been a problem in that the amount of a sludge solid component derived from the chemical agent is increased. In particular, when seawater is polluted with organic substances, this problem tends to become more serious.

### LIST OF LITERATURE

### Patent Literature

Patent Literature 1: Japanese Patent Publication 2010-131469 A

### Object and Summary of Invention

An object of the present invention is to provide a seawater treatment method in which after seawater is subjected to coagulation with a coagulant and solid-liquid separation, an RO treatment is performed on the seawater obtained thereby, RO feed water having a preferable water quality is obtained with a small addition amount of a coagulant, and by the RO treatment of the RO feed water, a stable RO treatment can be performed over a long period of time.

The present invention provides a seawater treatment method which is a pretreatment method performed prior to seawater membrane separation wherein a cationic organic flocculant and/or an inorganic coagulant is added to seawater to conduct a reaction, an alkaline solution of a high molecular weight compound which has a phenolic hydroxide and which is insolubilized under a high salt concentration is added to conduct a coagulation treatment, and subsequently, a solid-liquid separation treatment is performed.

The addition amount of the cationic organic flocculant to seawater is preferably 0.25 mg/L or less as an effective component, and the addition amount of a resin component of the alkaline solution of a high molecular weight compound which has a phenolic hydroxide and which is insolubilized under a high salt concentration is preferably 1.3 times or more the addition amount of the cationic organic flocculant.

In addition, it is preferable that the inorganic coagulant be an iron-based coagulant or an aluminum-based coagulant, the addition amount of the iron-based coagulant to seawater be 2.0 mg/L or less in the form of Fe, the addition amount of the aluminum-based coagulant to seawater be 5 mg/L or less in the form of Al₂O₃, and the addition amount of the resin component of the alkaline solution of a high molecular weight compound which has a phenolic hydroxide and which is insolubilized under a high salt concentration be 0.1 to 1 mg/L.

According to one aspect of the present invention, after seawater is pretreated by the seawater treatment method described above, the seawater is desalinated by performing a reverse osmosis membrane separation treatment.

### Advantageous Effects of Invention

Through intensive research carried out by the present inventors to overcome the problems described above, it was found that after a cationic organic flocculant and/or an inorganic coagulant is added to seawater to conduct a reaction, when an alkaline solution of a high molecular weight compound which has a phenolic hydroxide and which is insolubilized in seawater is added to conduct a reaction, treated water having a preferable SDI value can be obtained with or without using a very small amount of an inorganic coagulant.

This reaction mechanism may be construed as described below.

When added to seawater, the cationic organic flocculant reacts with, among algae and biopolymers produced microbiological metabolism in seawater, so-called acidic polysaccharides having anionic properties and forms fine particles. The particles thus formed have a very small particle diameter that may not be detected by a turbidity meter at a wavelength of 660 nm. After the addition of this cationic organic flocculant, when the alkaline solution of a high molecular weight compound having a phenolic hydroxide is added, the fine particles are coagulated and grown to have particle diameters which can be removed by solid-liquid separation. Since the alkaline solution of a high molecular weight compound having a phenolic hydroxide is insolubilized in seawater and then precipitated by itself, as in the case of the inorganic coagulant, a coagulation function can be obtained by adsorption and adhesion of fine particles. In addition, in seawater, the acidic polysaccharides having anionic properties are placed in a state in which the charge thereof is restricted by high concentration salts in seawater, and the charge repulsion is significantly reduced, and hence the acidic polysaccharides are coagulated by the high molecular weight compound having a phenolic hydroxide.

It may be construed that since a phenolic hydroxide has a slight dissociation property, a dissociated anion derived from this phenolic hydroxide electrostatically reacts with an unreacted cation remaining in seawater derived from the added cationic organic flocculant, and particles which can be removed by solid-liquid separation are formed.

By this treatment, compared to the treatment performed only by an inorganic coagulant such as ferric chloride, since the generation of solid components caused by addition of coagulant chemicals is reduced, preferable pretreated water equivalent or superior to that obtained by a ferric chloride treatment can be obtained.

In addition, when an inorganic coagulant such as ferric chloride is added to seawater, although fine particles and some biopolymers in seawater are coagulated, some fine hydroxide colloids which cannot be removed by solid-liquid separation are generated.

According to the present invention, when an alkaline solution of a high molecular weight compound having a phenolic hydroxide is added after the addition of an inorganic coagulant, the high molecular weight compound having a phenolic hydroxide adheres to fine colloids by its adhesion function, and the particle diameter thereof can be coarsely increased so as to be removable by solid-liquid separation.

On the other hand, when an inorganic coagulant is added after the addition of an alkaline solution of a phenolic high molecular weight compound as disclosed in Patent Literature 1, the phenolic high molecular weight compound is insolubilized in seawater, and after the adhesion force thereof is lost, the inorganic coagulant is added; hence, the function of adhering to fine colloids cannot be effectively used.

According to the present invention, the inorganic coagulant is added first, and immediately before the high molecular weight compound having a phenolic hydroxide, which is added later, is insolubilized, the adhesion force thereof can be made to work on fine colloids generated by the addition of the inorganic coagulant. Hence, preferable pretreated water can be obtained with a smaller addition amount of the inorganic coagulant than that of a related method, and in addition, fouling of solid-liquid separation devices caused by fine colloids, such as membrane fouling, can be prevented, so that a stable operation can be performed over a long period of time.

According to the treatment method of the present invention, regardless whether clean seawater or polluted seawater is used, an appropriate treatment can be performed without remarkably changing the addition amount of coagulant chemicals. Hence, the method of the present invention can be appropriately applied to wide variations, such as seasonal variations, in the degree of pollution of raw seawater.

### BRIEF DESCRIPTION OF DRAWINGS

FIG. 1 is a graph showing experimental results.

FIG. 2 is a graph showing experimental results.

FIG. 3 is a graph showing experimental results.

FIG. 4 is a graph showing experimental results.

FIG. 5 is a graph showing experimental results.

FIG. 6 is a graph showing experimental results.

FIG. 7 is a graph showing experimental results.

FIG. 8 is a graph showing experimental results.

FIG. 9 is a graph showing experimental results.

FIG. 10 is a graph showing experimental results.

FIG. 11 is a graph showing experimental results.

FIG. 12 is a graph showing experimental results.

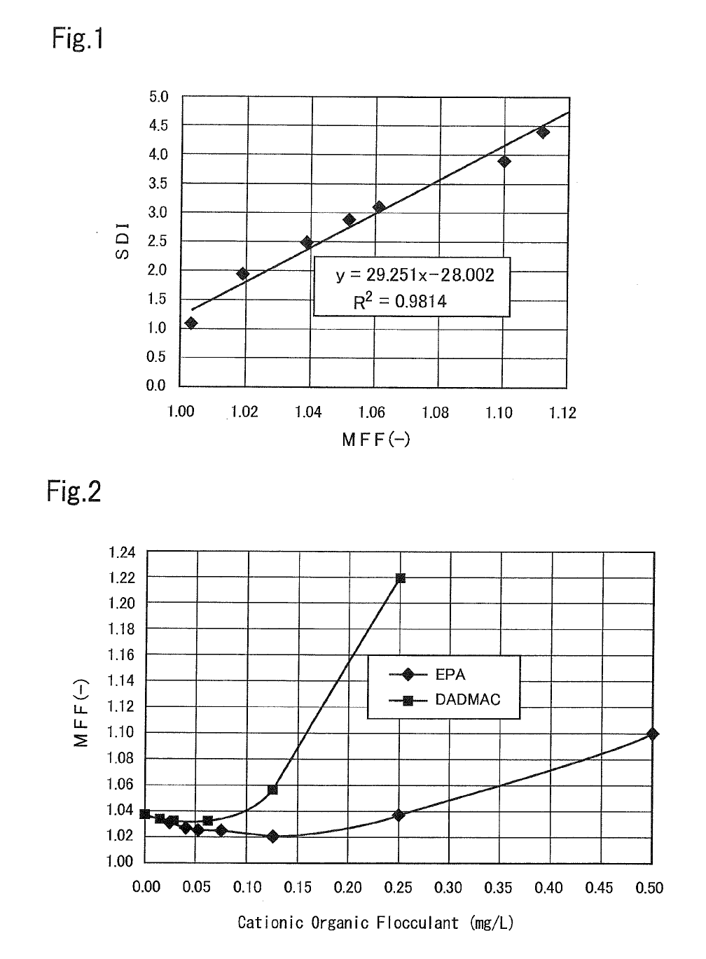

### DESCRIPTION OF EMBODIMENTS

Hereinafter, the present invention will be described in more detail.

According to the present invention, after a cationic organic flocculant and/or inorganic coagulant is added to seawater to conduct a reaction, an alkaline solution of a high molecular weight compound (hereinafter referred to as “phenolic high molecular weight compound” in some cases) which has a phenolic hydroxide and which is insolubilized under a high salt concentration is added to conduct a reaction. In addition, as for the order of addition of the cationic organic flocculant and/or the inorganic coagulant and the phenolic high molecular weight compound, the cationic organic flocculant and/or the inorganic coagulant is set to be added first.

When added after the addition of the phenolic high molecular weight compound, the cationic organic flocculant remains in water which is to be processed by filtration and causes RO membrane fouling, and hence, it is not preferable. In addition, when the inorganic coagulant is added after the addition of the phenolic high molecular weight compound, the adhesion force thereof cannot be made to effectively work on fine colloids generated by the addition of the inorganic coagulant, and hence, it is not preferable.

[Cationic Organic Flocculant]

As the cationic organic flocculant, any flocculants are not particularly limited as long as being commonly used for water treatment. In particular, for example, a polycondensate between epichlorohydrin and a dialkylamine, and addition polymers of polydiallyldimethylammonium and polydimethylamino(meth)acrylate may be mentioned.

The cationic organic flocculant preferably uses 1 N NaNO₃ as a solvent and preferably has a molecular weight corresponding to an inherent viscosity of less than 1.0 dL/g and in particular, 0.5 dL/g or less measured at 30° C.

The cationic organic flocculant may be directly added to seawater in the form of a liquid at a concentration of 25 to 50 wt % or may be added after being appropriately diluted.

However, after the cationic organic flocculant is diffused over the entire seawater to be treated, it is preferable to take a time before the phenolic high molecular weight compound is added, that is, it is preferable to take 3 minutes or more as a reaction time of the cationic organic flocculant. Hence, in order to shorten the diffusion time and to sufficiently progress the reaction, an addition method is preferably performed in such a way that while dilution water is intensively injected at a high flow rate Into a seawater pipe, the cationic organic flocculant is injected thereinto by a pump. In addition, this reaction time is preferably set to approximately 3 to 15 minutes in consideration of the treatment effect and the treatment efficiency.

The addition amount of the cationic organic flocculant to seawater as an effective component is preferably 0.03 to 0.25 mg/L and particularly preferably 0.05 to 0.15 mg/L. The optimum addition amount of the cationic organic flocculant is preferably determined in an experimental manner in accordance with the type of cationic organic flocculant and the degree of pollution of seawater.

[Inorganic Coagulant]

Although the inorganic coagulant is not particularly limited, for example, aluminum-based coagulants, such as poly(aluminum chloride) (PAC), aluminum sulfate, and aluminum chloride, and iron-based coagulants, such as ferric chloride, ferric sulfate, and poly(ferric sulfate), may be mentioned, and those mentioned above may be used alone, or at least two thereof may be used in combination.

As the inorganic coagulant, although a liquid product itself is generally added to seawater without being diluted, in order to promote the diffusion into seawater, the inorganic coagulant is preferably diluted immediately before the addition thereof.

In addition, after the inorganic coagulant is added, the time until the phenolic high molecular weight compound is added, that is, the reaction time for the inorganic coagulant, is preferably set to approximately 3 to 15 minutes in view of the treatment effect and the treatment efficiency.

In the case in which the inorganic coagulant is an iron-based coagulant such as ferric chloride, the addition amount thereof in the form of Fe to seawater is set to preferably 0.3 to 2.0 mg-Fe/L and particularly preferably 0.5 to 1.5 mg-Fe/L. In addition, in the case in which the inorganic coagulant is an aluminum-based coagulant, the addition amount thereof in the form of Al₂O₃ is set to preferably 1 to 5 mg/L and particularly preferably 1.5 to 3 mg/L. The optimum addition amount of the inorganic coagulant is preferably determined in an experimental manner in accordance with the type of inorganic coagulant and the degree of pollution of seawater.

[Phenolic High Molecular Weight Compound]

As the phenolic high molecular weight compound, that is, as the high molecular weight compound which has a phenolic hydroxide and which is insolubilized under a high salt concentration, at least one type of the following polyvinyl phenol)-based polymers and/or phenolic resins is preferable.

<Poly(Vinyl Phenol)-Based Polymer>

(1) Homopolymer of Vinyl Phenol

(2) Homopolymer of Modified Vinyl Phenol

(3) Copolymer of Vinyl Phenol and Modified Vinyl Phenol

(4) Copolymer of Hydrophobic Vinyl Monomer and Vinyl Phenol and/or Modified Vinyl Phenol

As the above modified vinyl phenol, for example, a vinyl phenol in which a phenyl group is chemically modified with some type of compound, such as a vinyl phenol replaced with an alkyl group, an allyl group, or the like or a halogenated vinyl phenol, may be mentioned.

In addition, as the hydrophobic vinyl monomer, for example, water-insoluble or low water-soluble vinyl monomers, such as ethylene, acrylonitrile, and methyl methacrylate, may be mentioned. The molar ratio of vinyl phenol and/or modified vinyl phenol in the copolymer of the hydrophobic vinyl monomer as described above and vinyl phenol and/or modified vinyl phenol is preferably 0.5 or more and particularly preferably 0.7 or more.

The weight average molecular weight (Mw) of this poly(vinyl phenol)-based polymer is preferably 1,000 or more, such as 1,000 to 100,000, and a polymer having the molecular weight as described above is generally supplied in the form of powder.

In addition, the molecular weight or the weight average molecular weight in the present invention is measured by a GPC method (gel permeation chromatography method) and is a value calculated using a calibration line prepared using standard polystyrenes.

<Phenolic Resin>

(1) Polycondensate of Phenol and Formaldehyde

(2) Polycondensate of Cresol and Formaldehyde

(3) Polycondensate of Xylenol and Formaldehyde

As the phenolic high molecular weight compounds mentioned above, for example, there may be a novolac type compound, a resol type compound, or a compound disclosed in Japanese Patent Publication 2011-056496 A which is obtained by further performing a resol-type secondary reaction on a novolac type phenolic resin, and all of those compounds may be effectively used.

In addition, the weight average molecular weight (Mw) of a novolac type phenolic resin and that of a resol type phenolic resin are each preferably 1,000 or more, such as 1,000 to 30,000.

In addition, since a low molecular weight component which is contained in the phenolic high molecular weight compound and which has a molecular weight of approximately 600 or less based on the styrene conversion is not involved in coagulation and remains in a treated liquid to cause membrane fouling, the phenolic high molecular weight compound preferably contains a small amount of the low molecular weight component.

[Alkaline Solution of Phenolic High Molecular Weight Compound]

Since being insoluble or poorly soluble in water, the phenolic high molecular weight compound described above is, for example, dissolved or a dispersed in a solvent soluble in water so as to be supplied in the form of a solution or an emulsion. As the solvent to be used, although water-soluble organic solvents, such as ketones including acetone, esters including methyl acetate, and alcohols including methanol, alkaline aqueous solutions, and amines may be mentioned by way of example, in the present invention, a solution formed using an alkaline chemical, such as sodium hydroxide (NaOH) or potassium hydroxide (KOH), is used.

As the alkali solution of the phenolic high molecular weight compound, an alkaline solution having a pH of 11 to 14 is preferable for the phenolic high molecular weight compound, and an alkaline solution having a pH of 12 to 13 is particularly preferable. As the alkali, for example, sodium hydroxide or potassium hydroxide may be used.

As the alkaline solution of the phenolic high molecular weight compound, in particular, an alkaline solution disclosed in Japanese Patent Publication 2011-056496 A is preferable which is obtained in such a way that an aldehyde and/or its derivative is added to a sodium hydroxide solution of a phenol-formaldehyde novolac type resin, and a resol type secondary reaction is then carried out in the presence of an alkali catalyst. The alkali solution thus obtained is preferable since a low molecular weight component having a molecular weight of approximately 600 or less is removed.

The alkali aqueous solution of the phenolic high molecular weight compound before dilution is generally prepared to have an alkaline chemical concentration of 3 to 25 wt/wt % and a phenolic high molecular weight compound concentration of 10 to 35 wt/wt %.

The phenolic high molecular weight compound is preferably added to seawater after being sufficiently diluted with water so that, in more precise, the resin component concentration is 0.01 to 0.1 wt % and in particular, approximately 0.03 to 0.1 wt %.

Unless sufficient dilution is performed, when being added to seawater, the phenolic high molecular weight compound is immediately insolubilized and is also simultaneously associated to form large precipitation particles, resulting in decrease in effect efficiency. In addition, when the diffusion is not sufficiently performed, by the same reason as described above, the effect efficiency is decreased.

The electrical conductivity of water to be used for dilution is preferably 200 mS/m or less and particularly preferably 100 mS/m or less. When the electrical conductivity of water to be used for dilution is 200 mS/m or more, the phenolic high molecular weight compound is liable to be insolubilized and precipitated in a dilution liquid. As the water to be used for dilution, RO treated water is preferable.

For dilution of the phenolic high molecular weight compound with dilution water, a method is preferable in which dilution water is injected at a high flow rate into a seawater pipe, and an alkaline solution of the phenolic high molecular weight compound is injected thereinto by a pump to promote the diffusion.

The addition amount of the phenolic high molecular weight compound to seawater to which the cationic organic flocculant is added is, as the resin component of the high molecular weight compound, preferably 0.1 to 1.0 mg/L and particularly preferably 0.2 to 0.7 mg/L. In addition, the addition amount of this phenolic high molecular weight compound is 1.3 times or more (on weight basis) the addition amount of the cationic organic flocculant and is preferably, for example, 1.3 to 30 times and particularly preferably in a range of approximately 2 to 15 times.

In addition, in view of the addition cost and the treatment effect, the addition amount of the phenolic high molecular weight compound to seawater to which the inorganic coagulant is added is, as the resin component of the phenolic high molecular weight compound, preferably 0.1 to 1.0 mg/L and particularly preferably in a range of approximately 0.2 to 0.7 mg/L.

[Concomitant Use of Cationic Organic Flocculant and Inorganic Coagulant]

In the present invention, for concomitant use of the cationic organic flocculant and the inorganic coagulant, after the cationic organic flocculant and the inorganic coagulant are added, the alkaline solution of the phenolic high molecular weight compound may be added. In this case, the cationic organic flocculant and the inorganic coagulant may be added before the addition of the alkaline solution of the phenolic high molecular weight compound. Although the cationic organic flocculant and the inorganic coagulant may be simultaneously added, the inorganic coagulant may be added after the addition of the cationic organic flocculant, or the cationic organic flocculant may be added after the addition of the inorganic coagulant, the cationic organic flocculant is preferably added first.

When the cationic organic flocculant and the inorganic coagulant are concomitantly used, the addition amount of the cationic organic flocculant and that of the inorganic coagulant are appropriately determined in accordance with the types of cationic organic flocculant and inorganic coagulant to be used and the degree of pollution of seawater. However, the addition amount of the cationic organic flocculant is preferably 0.03 to 0.25 mg/L and particularly preferably 0.05 to 0.15 mg/L, and in the case of an iron-based coagulant such as ferric chloride, the addition amount of the inorganic coagulant in the form of Fe is preferably 0.3 to 2.0 mg/L and particularly preferably 0.3 to 1.0 mg/L.

In addition, the addition amount of the phenolic high molecular weight compound after the addition of the cationic organic flocculant and the inorganic coagulant is, as the resin component of the phenolic high molecular weight compound, preferably 0.1 to 1.0 mg/L and particularly preferably in a range of approximately 0.15 to 0.50 mg/L.

[Solid-Liquid Separation Method]

As a solid-liquid separation method performed after the coagulation treatment, for example, gravity double-layer filtration or pressure double-layer filtration is preferable. The LV thereof is preferably 5 to 15 m/Hr and particularly preferably in a range of approximately 7 to 12 m/Hr.

### EXAMPLES

Hereinafter, Examples and Comparative Examples will be described. In the following Experiment I (Examples I-1 to I-10, Comparative Examples I-1 to I-9) and Experiment III (Examples III-1 to III-10, Comparative Examples III-1 to III-13), as water to be treated, relatively clean seawater (hereinafter referred to as “seawater”) was used, and in the following Experiment II (Examples II-1 to II-15, Comparative Examples II-1 to II-8) and Experiment IV (Examples IV-1 to IV-8, Comparative Examples IV-1 to IV-16), as water to be treated, artificially polluted seawater (hereinafter referred to as “polluted seawater”) was used.

Cationic organic flocculants, inorganic coagulants, and phenolic high molecular weight compounds, and test methods used in Experiments I to IV are as described below.

[Cationic Organic Flocculant]

Cationic organic flocculant 1 (hereinafter referred to as “EPA”): Commercial product in the form of a liquid condensate between epichlorohydrin and an amine (FL2749 manufactured by SNF), colloid equivalent: 6.8 meq/l, inherent viscosity as the molecular weight index measured in 1 N—NaNO₃ at 30° C.: 0.14 dL/g, concentration: 50 wt %.

Cationic organic flocculant 2 (hereinafter referred to as “DADMAC”): Commercial product of a liquid poly(diallyldimethylammonium chloride) (FL4820 manufactured by SNF), colloid equivalent: 6.2 meq/l, inherent viscosity as the molecular weight index measured in 1 N—NaNO₃ at 30° C.: 0.77 dL/g, concentration: 25 wt %.

The cationic organic flocculants were added after being diluted with purified water to have a chemical concentration of 0.022 wt % (in the case of the cationic organic flocculant 1) or 0.011 wt % (in the case of the cationic organic flocculant 2). The addition amounts of the cationic organic flocculants shown in the following Tables 1 and 2 each indicate the addition amount as the effective component.

[Alkaline Solution of Phenolic High Molecular Weight Compound]

As the alkaline solution of the phenolic high molecular weight compound, the following solutions i) and ii) were used. Those alkaline solutions were both insolubilized in seawater.

i) An alkaline solution (hereinafter referred to as “PPF”) of phenolic high molecular weight compound described in Japanese Patent Publication 2011-056496 A. The alkaline solution is obtained by adding an aldehyde and/or its derivative to a sodium hydroxide solution of a phenol-formaldehyde novolac type resin, followed by performing a resol type secondary reaction in the presence of an alkaline catalyst. The alkaline solution has an effective component concentration of 16%, where the component has a polystyrene-conversion weight average molecular weight of 12,000 and a melting point of 170° C.

ii) An alkaline solution (hereinafter referred to as “PVPF”) of a poly(vinyl phenol) having a polystyrene-conversion weight average molecular weight of 2,000 (effective component concentration: 18%).

The alkaline solution of each phenolic high molecular weight compound was diluted with purified water to have a resin component concentration of 0.22 wt % and was then added. The addition amounts of the phenolic high molecular weight compounds shown in the following Tables 1 to 4 each indicate the addition amount as the resin component.

[Inorganic Coagulant]

Ferric chloride (FeCl₃) in the form of a 38-wt % aqueous solution was added.

The addition amounts of ferric chloride shown in the following Tables 1 and 2 each indicate the Fe element-based addition amount. In addition, in Tables 3 and 4, the addition amount of a ferric chloride product (containing 38% of FeCl₃) and the Fe element-based addition amount are both shown.

### Test Method

### Cases of Experiments I and II

A coagulation treatment was performed by placing 1,100 mL of water to be treated (seawater or polluted seawater) at 24° C. in a beaker, adding dilution water of the cationic organic flocculant, and stirring at 150 rpm for 7 minutes. Subsequently, a coagulation treatment was further performed by adding dilution water of the alkaline solution of the phenolic high molecular weight compound while stirring was performed at 150 rpm for 3 minutes, followed by further performing stirring at 50 rpm for 10 minutes.

Next, this coagulation-treated water was filtered with two pieces of No. 5A filter paper laminated to each other, so that a solid-liquid separation treatment was performed.

MFF of this solid-liquid separation treated water (24° C.) was measured by the method described in the column of the above Background Art.

In addition, a solid component amount (solid component amount per 1 L of water to be treated (mg), hereinafter referred to as “solid component generation amount”) generated by the solid-liquid separation was measured.

### Cases of Experiments III and IV

A coagulation treatment was performed by placing 1,100 mL of water to be treated (seawater or polluted seawater) at 24° C. in a beaker, adding the inorganic coagulant (ferric chloride), and stirring at 150 rpm for 7 minutes. Subsequently, a coagulation treatment was further performed by adding dilution water of the alkaline solution of the phenolic high molecular weight compound while stirring was performed at 150 rpm for 3 minutes, followed by further performing stirring at 50 rpm for 10 minutes.

Next, this coagulation-treated water was filtered with two pieces of No. 5A filter paper laminated to each other, so that a solid-liquid separation treatment was performed.

MFF of this solid-liquid separation treated water (24° C.) was measured by the method described in the column of the above Background Art.

In addition, the degree of whiteness (%) of an MF membrane, the MFF of which was already measured, was measured by a color meter manufactured by TECHNIDYNE Corp. When fine colloids of iron hydroxides generated by the addition of ferric chloride are trapped by and adhered to the MF membrane, the MF membrane is colored yellow by iron, so that the degree of whiteness is degraded. Hence, it is indicated that as the degree of whiteness is decreased (lower degree of whiteness), the amount of fine colloids of iron hydroxides is increased, and the membrane fouling of the MF membrane becomes serious. On the other hand, a higher degree of whiteness indicates that no membrane fouling problem occurs and that a stable treatment can be performed.

### Experiment I

### Examples I-1 to I-10

As the seawater, seawater collected in Chatan-cho, Okinawa prefecture was controlled at a temperature of 24° C., and a test was performed in accordance with the above-described test method using the cationic organic flocculant and the phenolic high molecular weight compound shown in Table 1. The addition amounts of the cationic organic flocculant and the phenolic high molecular weight compound, the MFF measured value, and the solid component generation amount are shown in Table 1. An estimated SDI value estimated from MFF is also shown in Table 1.

### Comparative Examples I-1 to I-9

The contents of Comparative Examples are as described below.

Comparative Example I-1: The filtration treatment was only performed without performing the coagulation treatment, and MFF was measured.
Comparative Examples I-2 and I-3: As the coagulant, ferric chloride was added. The phenolic high molecular weight compound was not added. The other conditions were the same as those of Example.
Comparative Example I-4: As the coagulant, the phenolic high molecular weight compound was only used. The cationic organic flocculant was not added. The other conditions were the same as those of Example.
Comparative Examples I-5 and I-6: As the coagulant, the cationic organic flocculant was only used. The phenolic high molecular weight compound was not added. The other conditions were the same as those of Example.
Comparative Examples I-7 and I-8: Although the cationic organic flocculant and the phenolic high molecular weight compound were both used, the phenolic high molecular weight compound was added first, and the cationic organic flocculant was added later. The other conditions were the same as those of Example.
Comparative Example I-9: Ferric chloride and the phenolic high molecular weight compound were used without using the cationic organic flocculant. However, the phenolic high molecular weight compound was added first, and ferric chloride was added later. The other conditions were the same as those of Example.

The results are shown in Table 1.

TABLE 1

| | | | Phenolic High | | | | | |
|---|---|---|---|---|---|---|---|---|
| | | | Molecular Weight | | Ratio in Addition | Solid | | |
| | Coagulant | | Compound | | Amount of Phenolic | Component | | |
| | | Addition | | Addition | High Molecular | Generation | | |
| | | Amount | | Amount | Weight | Amount | | Estimated |
| No. | Type | (mg/L) | Type | (mg/L) | Compound/Cation | (mg/L) | MFF Value | SDI value |
| Comparative | — | — | — | — | — | 0.00 | 1.072 | 3.34 |
| Example I-1 | | | | | | | | |
| Comparative | FeCl₃ | 0.393asFe | — | — | — | 0.56 | 1.041 | 2.43 |
| Example I-2 | | | | | | | | |
| Comparative | FeCl₃ | 0.655asFe | — | — | — | 0.94 | 1.040 | 2.41 |
| Example I-3 | | | | | | | | |
| Comparative | — | — | PPH | 0.32 | — | 0.32 | 1.036 | 2.30 |
| Example I-4 | | | | | | | | |
| Example I-1 | EPA | 0.03 | PPH | 0.32 | 10.7 | 0.35 | 1.026 | 2.00 |
| Example I-2 | EPA | 0.05 | PPH | 0.32 | 6.4 | 0.37 | 1.025 | 1.99 |
| Example I-3 | EPA | 0.075 | PPH | 0.32 | 4.3 | 0.40 | 1.024 | 1.95 |
| Example I-4 | EPA | 0.125 | PPH | 0.32 | 2.6 | 0.45 | 1.022 | 1.89 |
| Example I-5 | EPA | 0.25 | PPH | 0.32 | 1.28 | 0.57 | 1.033 | 2.22 |
| Example I-6 | DADMAC | 0.015 | PPH | 0.32 | 21.3 | 0.34 | 1.030 | 2.14 |
| Example I-7 | DADMAC | 0.025 | PPH | 0.32 | 12.8 | 0.35 | 1.032 | 2.19 |
| Example I-8 | DADMAC | 0.0375 | PPH | 0.32 | 8.5 | 0.36 | 1.024 | 1.96 |
| Example I-9 | DADMAC | 0.0875 | PPH | 0.32 | 3.7 | 0.41 | 1.032 | 2.18 |
| Example I-10 | EPA | 0.125 | PVPF | 0.36 | 2.9 | 0.49 | 1.024 | 1.95 |
| Comparative | EPA | 0.075 | — | — | 0.0 | 0.08 | 1.077 | 3.51 |
| Example I-5 | | | | | | | | |
| Comparative | DADMAC | 0.0375 | — | — | 0.0 | 0.04 | 1.081 | 3.62 |
| Example I-6 | | | | | | | | |
| Comparative | EPA | 0.075 | PPH | 0.32 | 4.3 | 0.40 | 1.041 | 2.45 |
| Example I-7 | | | | | | | | |
| Comparative | DADMAC | 0.0375 | PPH | 0.32 | 8.5 | 0.36 | 1.053 | 2.81 |
| Example I-8 | | | | | | | | |
| Comparative | FeCl₃ | 0.393asFe | PPH | 0.32 | — | 0.88 | 1.039 | 2.40 |
| Example I-9 | | | | | | | | |

### DISCUSSION

The seawater used in Experiment I was relatively clean, and when the filtration treatment was only performed, as shown in Comparative Example I-1, an MFF of 1.072 (an estimated SDI value of 3.34) was obtained.

In Comparative Example I-2 in which 3 mg/L (0.39 mg/L as Fe) of ferric chloride (38% FeCl₃) was added, a superior MFF of 1.041 and a superior estimated SDI value of 2.43 were obtained.

In Comparative Example I-4 in which 0.32 mg/L of PPH was added, a superior effect to that of each of Comparative Examples I-2 and I-3 in which a ferric chloride solution was only added was obtained.

In Examples I-1 to I-5, the addition amount of PPH was fixed to 0.32 mg/L, and the addition amount of the cationic organic flocculant EPA was changed. In Examples I-1 to I-4, the effects were all more superior to that of each of Comparative Examples I-2 to I-4, and the estimated SDI value was improved to approximately 2 or less.

Example I-5 was the case in which since the addition amount of EPA was increased to 0.25 mg/L, PPH/EPA was decreased to 1.3 or less. In this case, although being superior to the effect of Comparative Example I-4 in which no EPA was added, the effect was inferior to that of Example I-4 in which the addition amount was small.

In Examples I-6 to I-10, the results of which were each superior to that of Comparative Example I-4 in which no cationic flocculant was added.

Comparative Examples I-5 and I-6 were the cases in each of which only the cationic organic flocculant was only added without using the phenolic high molecular weight compound. In both cases, the results were each inferior to that of Comparative Example I-1 in which no chemicals were added.

Comparative Examples I-7 and I-8 were the cases in each of which the order of addition of the cationic organic flocculant and the phenolic high molecular weight compound was set to be opposite, and the results were each inferior to that of Comparative Example I-4.

Comparative Example I-9 was the case in which the phenolic high molecular weight compound was added first, and ferric chloride was then added, and the result was superior to that of Comparative Example I-2 but inferior to that of Comparative Example I-4.

In addition, FIG. 2 shows the relationship between the addition amount of the cationic organic flocculant and MFF obtained when 0.32 mg/L of PPF is added. As shown in FIG. 2, it was found that the addition amount of EPA was preferably 0.25 mg/L or less, and that in the case of using DADMAC, 0.10 mg/L or less was preferable.

### Experiment II

### Examples II-1 to II-15

After 3 mg/L of acetic acid was added to the seawater of Experiment I, and oxygen was sufficiently supplied therein by aeration for 1 hour, the seawater was left still at 20° C. to 25° C. for 5 days to propagate naturally occurring marine microorganisms, so that polluted seawater was prepared. This polluted seawater was used as water to be treated, and a test similar to that of Experiment I was performed.

The types and the amounts of the cationic organic flocculant and the phenolic high molecular weight compound are as shown in Table 2. The solid component generation amount, the measured MFF value, and the estimated SDI value are shown in Table 2.

### Comparative Examples II-1 to II-8

The contents of Comparative Examples are as described below.

Comparative Example II-1: The filtration treatment was only performed without performing the coagulation treatment, and MFF was measured.
Comparative Examples II-2 to II-5: Ferric chloride (FeCl₃) was added as the coagulant. The phenolic high molecular weight compound was not added. The other conditions were the same as those of Example.
Comparative Example II-6: The phenolic high molecular weight compound was only used as the coagulant. The cationic organic flocculant was not added. The other conditions were the same as those of Example.
Comparative Example II-7: The cationic organic flocculant was only used as the coagulant. The phenolic high molecular weight compound was not added. The other conditions were the same as those of Example.
Comparative Example II-8: Although the cationic organic flocculant and the phenolic high molecular weight compound were used, the phenolic high molecular weight compound was added first, and the cationic organic flocculant was added later. The other conditions were the same as those of Example.

The results are shown in Table 2.

TABLE 2

| | | | Phenolic High | | | | | |
|---|---|---|---|---|---|---|---|---|
| | | | Molecular Weight | | Ratio in Addition | Solid | | |
| | Coagulant | | Compound | | Amount of Phenolic | Component | | |
| | | Addition | | Addition | High Molecular | Generation | | |
| | | Amount | | Amount | Weight | Amount | | Estimated |
| No. | Type | (mg/L) | Type | (mg/L) | Compound/Cation | (mg/L) | MFF Value | SDI value |
| Comparative | — | — | — | — | — | 0.00 | 1.268 | 6.6< |
| ExampleII-1 | | | | | | | | |
| Comparative | FeCl₃ | 0.393asFe | — | — | — | 0.56 | 1.102 | 4.24 |
| Example II-2 | | | | | | | | |
| Comparative | FeCl₃ | 0.655asFe | — | — | — | 0.94 | 1.099 | 4.15 |
| Example II-3 | | | | | | | | |
| Comparative | FeCl₃ | 1.18asFe | — | — | — | 1.68 | 1.082 | 3.63 |
| Example II-4 | | | | | | | | |
| Comparative | FeCl₃ | 1.97asFe | | — | — | 2.80 | 1.092 | 3.93 |
| Example II-5 | | | | | | | | |
| Comparative | — | — | PPH | 0.32 | — | 0.32 | 1.132 | 5.10 |
| Example II-6 | | | | | | | | |
| Example II-1 | EPA | 0.03 | PPH | 0.32 | 10.7 | 0.35 | 1.098 | 4.12 |
| Example II-2 | EPA | 0.05 | PPH | 0.32 | 6.4 | 0.37 | 1.094 | 3.98 |
| Example II-3 | EPA | 0.075 | PPH | 0.32 | 4.3 | 0.40 | 1.091 | 3.91 |
| Example II-4 | EPA | 0.125 | PPH | 0.32 | 2.6 | 0.45 | 1.079 | 3.57 |
| Example II-5 | EPA | 0.175 | PPH | 0.32 | 1.8 | 0.50 | 1.082 | 3.65 |
| Example II-6 | EPA | 0.25 | PPH | 0.32 | 1.3 | 0.57 | 1.083 | 3.67 |
| Example II-7 | EPA | 0.40 | PPH | 0.32 | 0.8 | 0.72 | 1.095 | 4.03 |
| Example II-8 | EPA | 0.125 | PPH | 0.21 | 1.7 | 0.34 | 1.120 | 4.76 |
| Example II-9 | EPA | 0.125 | PPH | 0.48 | 3.8 | 0.61 | 1.060 | 3.00 |
| Example II-10 | DADMAC | 0.01 | PPH | 0.32 | 32.0 | 0.33 | 1.110 | 4.47 |
| Example II-11 | DADMAC | 0.015 | PPH | 0.32 | 21.3 | 0.34 | 1.095 | 4.02 |
| Example II-12 | DADMAC | 0.025 | PPH | 0.32 | 12.8 | 0.35 | 1.091 | 3.91 |
| Example II-13 | DADMAC | 0.0375 | PPH | 0.32 | 8.5 | 0.36 | 1.098 | 4.12 |
| Example II-14 | DADMAC | 0.0625 | PPH | 0.32 | 5.1 | 0.38 | 1.106 | 4.36 |
| Example II-15 | EPA | 0.125 | PVPF | 0.36 | 2.9 | 0.49 | 1.081 | 3.62 |
| Comparative | EPA | 0.125 | | | 0.0 | 0.13 | 1.255 | 6.6< |
| Example II-7 | | | | | | | | |
| Comparative | EPA | 0.125 | PPH | 0.32 | 2.6 | 0.45 | 1.141 | 5.38 |
| Example II-8 | | | | | | | | |

### DISCUSSION

When the polluted seawater used in Experiment II was not processed by a coagulation treatment with chemicals, as shown in Comparative Example II-1, the MFF value was 1.268, and the estimated SDI value was 6.6 or more which was beyond the measurable level; hence, this seawater could not be supplied to membrane filtration due to its inferior water quality.

As the case in which ferric chloride was only added, in Comparative Example II-4 in which the addition amount was increased to 1.18 mg/L as Fe, an MFF value of 1.082 and an estimated SDI value of 3.63 could be obtained. However, even if the addition amount was increased as that in Comparative Example II-5, the MFF value was not improved.

In Comparative Example II-6 in which 0.32 mg/L of PPH was added, although the MFF value was improved as compared to that in Comparative Example II-1 in which no chemicals were added, the MFF value was 1.132, and the estimated SDI value was 5.10, so that the effect was inferior.

Examples II-1 to II-7 were the cases in each of which the addition amount of PPH was fixed to 0.32 mg/L, and the addition amount of the cationic organic flocculant EPA was changed.

When the addition amount of EPA was 0.25 mg/L or less, as the addition amount was increased, the effect was improved, and when the addition amount of EPA was 0.125 to 0.25 mg/L, an effect equivalent to the best effect of a ferric chloride treatment in Comparative Example II-4 could be obtained.

Examples II-8 and II-9 were the cases in each of which the addition amount of PPH was increased or decreased with respect to that of Example II-4. In Example II-9 in which the addition amounts of EPA and PPH were set to 0.125 and 0.48 mg/L, respectively, the best results in Experiment II, that is, an MFF value of 1.060 and an estimated SDI value of 3.00, could be obtained.

Examples II-10 to II-14 were the cases in each of which the addition amount of PPH was fixed to 0.32 mg/L, and the addition amount of the cationic organic flocculant DADMAC was changed. In Examples II-10 to II-14, although the effects were not equivalent to the best effect of a ferric chloride solution, as compared to Comparative Example II-6 in which 0.32 mg/L of PPH was only added, improvements in MFF value and estimated SDI value were observed.

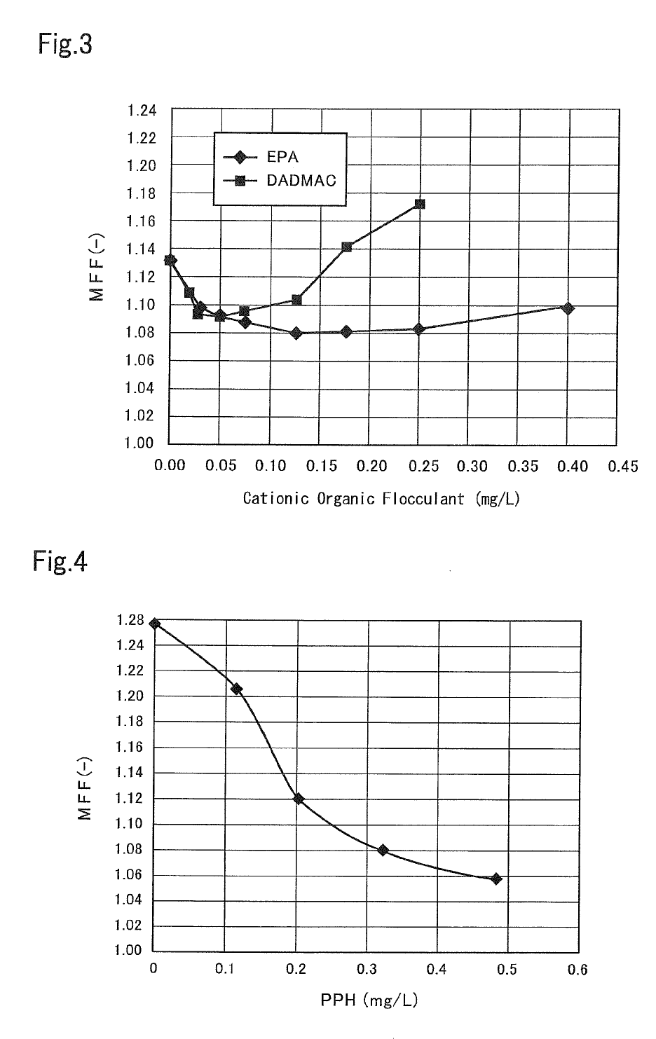

FIG. 3 shows the relationship between the addition amount of the cationic organic flocculant EPA and the addition amount of DADMAC obtained when the addition amount of PHH is fixed to 0.32 mg/L. The effect of the cationic organic flocculant can be maximized when the addition amount of EPA and that of DADMAC are set to 0.125 to 0.25 mg/L and 0.025 mg/L, respectively. As a factor causing the above difference therebetween, the difference in inherent viscosity which is the molecular weight index may be considered as in the case of clear seawater.

In addition, although an addition amount of EPA at which the effect can be maximized is approximately two times that in the case of clean seawater, an addition amount of DADMAC at which the effect can be maximized is similar to or slightly smaller than that in the case of clear seawater; hence, it may also be construed that the reactivity of DADMAC with biopolymers is low from a structural point of view.

In any of Examples, the amount of the solid component generated from the coagulant is decreased as compared to that of the treatment by the ferric chloride solution in Comparative Examples II-2 to II-5.

In Example II-15 in which PVPF was used as the phenolic high molecular weight compound, a preferable result could be obtained.

In Comparative Example II-7 in which no phenolic high molecular weight compound was used, and EPA was only used, the result could be hardly improved from that in Comparative Example II-1 in which no chemicals were used.

FIG. 4 is a graph showing the change in MFF obtained when the addition amount of EPA is fixed to 0.25 mg/L and the addition amount of PPH is changed from 0 to 0.48 mg/L. As shown in FIG. 4, as the addition amount of PPH is increased, the MFF value and the estimated SDI value are improved. In addition, a preferable addition amount of PPH in the case of polluted seawater may be judged to be 0.48 mg/L. In this case, the PPH/EPA ratio is 3.8.

In Comparative Example II-8 in which the order of addition was set to be opposite, the result was inferior.

### Experiment III

### Examples III-1 to III-10

As the seawater, seawater collected in Chatan-cho, Okinawa prefecture was controlled at a temperature of 24° C., and a test was performed in accordance with the above-described test method using ferric chloride and the phenolic high molecular weight compound shown in Table 3. The addition amounts of ferric chloride and the phenolic high molecular weight compound, the measured MFF value, and the degree of whiteness of the MF membrane are as shown in Table 3. An estimated SDI value estimated from the MFF is also shown in Table 3.

### Comparative Examples III-1 to III-13

The contents of Comparative Examples are as described below.

Comparative Example III-1: The filtration treatment was only performed without performing the coagulation treatment, and MFF and the degree of whiteness of the MF membrane were measured.
Comparative Examples III-2 to III-4: As the coagulant, ferric chloride was only used. The phenolic high molecular weight compound was not added. The other conditions were the same as those of Example.
Comparative Examples III-5 and III-9: As the coagulant, the phenolic high molecular weight compound was only used. Ferric chloride was not added. The other conditions were the same as those of Example.
Comparative Examples III-6 to III-8 and III-10 to III-13: The phenolic high molecular weight compound was added first, and ferric chloride was added later. The other conditions were the same as those of Example.

The results are shown in Table 3. In addition, in Table 3, “After” in the column of the order of addition indicates that the phenolic high molecular weight compound is added after the addition of ferric chloride, and “Before” indicates that the phenolic high molecular weight compound is added before the addition of ferric chloride.

TABLE 3

| | Addition Amount of | | Phenolic High | | | | | |
|---|---|---|---|---|---|---|---|---|
| | Ferric Chloride | | Molecular Weight | | | | | |
| | Amount of | | Compound | | | | | Degree of |
| | Product | Fe Element- | | Addition | | | | Whiteness of |
| | (38% FeCl₃) | Based Amount | | Amount | Order of | MFF | Estimated | MF Membrane |
| | (mg/L) | (mg/L) | Type | (mg/L) | Addition | Value | SDI Value | (%) |
| Comparative | 0.0 | 0.00 | — | — | — | 1.105 | 4.31 | 94.82 |
| Example III-1 | | | | | | | | |
| Comparative | 2.5 | 0.33 | — | — | — | 1.058 | 2.95 | 92.88 |
| Example III-2 | | | | | | | | |
| Comparative | 5.0 | 0.66 | — | — | — | 1.051 | 2.74 | 92.84 |
| Example III-3 | | | | | | | | |
| Comparative | 8.0 | 1.05 | — | — | — | 1.043 | 2.49 | 93.50 |
| Example III-4 | | | | | | | | |
| Comparative | — | | PPH | 0.16 | — | 1.071 | 3.32 | 93.23 |
| Example III-5 | | | | | | | | |
| Example III-1 | 2.5 | 0.33 | PPH | 0.16 | After | 1.025 | 1.99 | 93.49 |
| Example III-2 | 5.0 | 0.66 | PPH | 0.16 | After | 1.024 | 1.94 | 94.09 |
| Example III-3 | 8.0 | 1.05 | PPH | 0.16 | After | 1.021 | 1.86 | 93.89 |
| Comparative | 2.5 | 0.33 | PPH | 0.16 | Before | 1.048 | 2.65 | 93.14 |
| Example III-6 | | | | | | | | |
| Comparative | 5.0 | 0.66 | PPH | 0.16 | Before | 1.044 | 2.54 | 93.24 |
| Example III-7 | | | | | | | | |
| Comparative | 8.0 | 1.05 | PPH | 0.16 | Before | 1.039 | 2.39 | 93.67 |
| Example III-8 | | | | | | | | |
| Comparative | — | — | PPH | 0.32 | — | 1.035 | 2.28 | 94.35 |
| Example III-9 | | | | | | | | |
| Example III-4 | 2.5 | 0.33 | PPH | 0.32 | After | 1.020 | 1.84 | 94.75 |
| Example III-5 | 5.0 | 0.66 | PPH | 0.32 | After | 1.020 | 1.83 | 94.66 |
| Comparative | 2.5 | 0.33 | PPH | 0.32 | Before | 1.028 | 2.07 | 93.45 |
| Example III-10 | | | | | | | | |
| Comparative | 5.0 | 0.66 | PPH | 0.32 | Before | 1.026 | 2.01 | 93.58 |
| Example III-11 | | | | | | | | |
| Example III-6 | 2.5 | 0.33 | PPH | 0.10 | After | 1.038 | 2.36 | 92.80 |
| Example III-7 | 2.5 | 0.33 | PPH | 0.16 | After | 1.025 | 1.99 | 93.49 |
| Example III-8 | 2.5 | 0.33 | PPH | 0.32 | After | 1.020 | 1.84 | 94.75 |
| Example III-9 | 2.5 | 0.33 | PPH | 0.48 | After | 1.021 | 1.87 | 94.27 |
| Comparative | 2.5 | 0.33 | PPH | 0.48 | Before | 1.024 | 1.95 | 93.77 |
| Example III-12 | | | | | | | | |
| Example III-10 | 2.5 | 0.33 | PVPF | 0.16 | After | 1.027 | 2.04 | 93.44 |
| Comparative | 2.5 | 0.33 | PVPF | 0.16 | Before | 1.052 | 2.77 | 93.05 |
| Example III-13 | | | | | | | | |

### DISCUSSION

The seawater used in Experiment III was relatively clean, and when the filtration treatment was only performed, an MFF of 1.105 (estimated SDI value: 4.31) was obtained as shown in Comparative Example III-1; however, this value was slightly insufficient as RO feed water.

In Comparative Examples III-2 to III-4 in which 2.5 to 8.0 mg/L (0.33 to 1.05 mg/L as Fe) of ferric chloride (38% FeCl₃) was added, as the addition amount was increased, the quality of treated water was improved, and in Comparative Example III-4, an MFF of 1.043 and an estimated SDI value of 2.49 were obtained.

In Comparative Example III-5 in which 0.16 g/mL of PPH was added, although an significant effect could not be obtained, in Comparative Example III-9 in which 0.32 mg/L of PPH was added, an effect superior to that of Comparative Examples III-2 to III-4 in which a ferric chloride solution was only added was obtained.

Examples III-1 to III-3 were the cases in each of which the addition amount of PPH was fixed to 0.16 mg/L, and the addition amount of ferric chloride was changed. In all Experiment Examples III-1 to III-3, the effect was superior to that of each of Comparative Examples III-2 to III-5, and the estimated SDI value was 2 or less. In addition, the degree of whiteness of the MF membrane was also high.

On the other hand, even if the same addition amounts of ferric chloride and PPH were used as those of Examples III-1 to III-3, in Comparative Examples III-6 to III-8 in which PPH was added first, and ferric chloride was added later, the estimated SDI value was approximately 2.5, and the degree of whiteness of the MF membrane was also inferior.

Examples III-4 and III-5 were the cases in each of which the addition amount of PPH was fixed to 0.32 mg/L, and the addition amount of ferric chloride was changed, and results superior to that of each of Examples III-1 to III-3 were obtained.

In addition, when Examples III-4 and III-5 were compared to Comparative Examples III-10 and III-11 in which the same addition amounts of ferric chloride and PPH were used as those of Examples III-4 and III-5, PPH was added first, and ferric chloride was added later, it is found that ferric chloride is preferably added before PPH is added.

Examples III-6 to III-9 were the cases in each of which the addition amount of ferric chloride was fixed to 0.33 mg/L as Fe, and the addition amount of PHH was changed, and in Comparative Example III-12, the order of addition of ferric chloride and PPH was set to be opposite to that of Example III-9.

In addition, in Example III-10 and Comparative Example III-13, the same addition amount of PVPF was used as the phenolic high molecular weight compound, and the order of addition was set to be opposite to each other. From those Examples and Comparative Examples, it is also found that a high coagulation effect can be obtained when ferric chloride as the inorganic coagulant is added before the addition of the phenolic high molecular weight compound. In addition, for example, when Example III-1 in which 0.33 mg/L as Fe of ferric chloride and 0.16 mg/L of PPH were added was compared to III-8 in which 1.05 mg/L as Fe of ferric chloride and 0.16 mg/L of PPH were added, and the order of addition was set to be opposite, a significantly excellent treatment effect could be obtained in Example I-1. Hence, it is found that according to the present invention, when the inorganic coagulant is added first, and the phenolic high molecular weight compound is added later, preferably treated water can be obtained with a small addition amount of the inorganic coagulant as compared to that in the case in which the phenolic high molecular weight compound is added first, and the inorganic coagulant is added later.

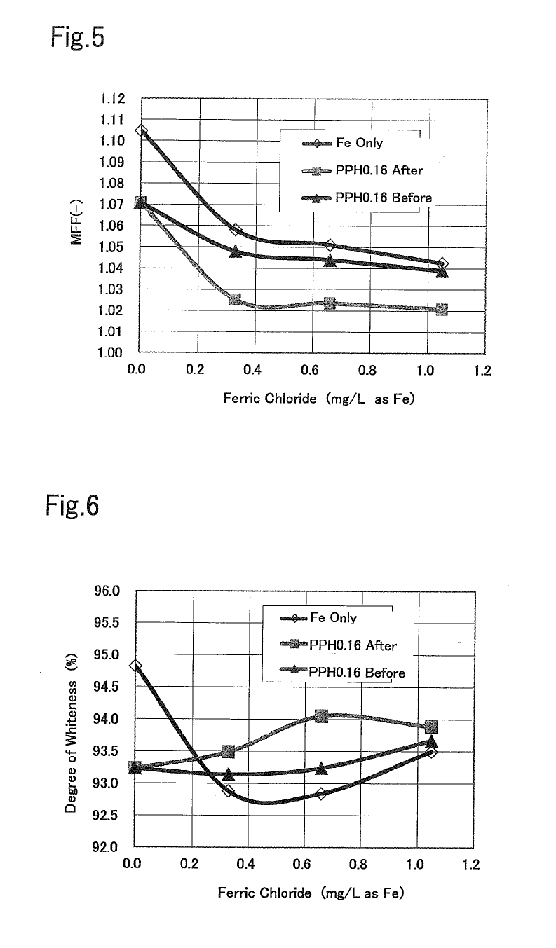

FIG. 5 shows the relationship between MFF and the addition amount of ferric chloride obtained when the addition amount of PPH is fixed constant to 0.16 mg/L and the addition amount of ferric chloride is changed and the relationship between MFF and the addition amount of ferric chloride obtained when ferric chloride is only added, and FIG. 6 shows the relationship between the addition amount of ferric chloride and the degree of whiteness of the MF membrane.

In FIGS. 5 and 6, “PPH0.16 After” indicates the case of Example of the present invention in which 0.16 mg/L of PPH is added after the addition of ferric chloride, and “PPH 0.16 Before” indicates the case of Comparative Example in which 0.16 mg/L of PPH is added before the addition of ferric chloride.

From FIGS. 5 and 6, it is found that in the present invention, the addition amount of ferric chloride is preferably 0.3 to 1.2 mg/L as Fe and particularly preferably in a range of approximately 0.6 to 0.8 mg/L as Fe.

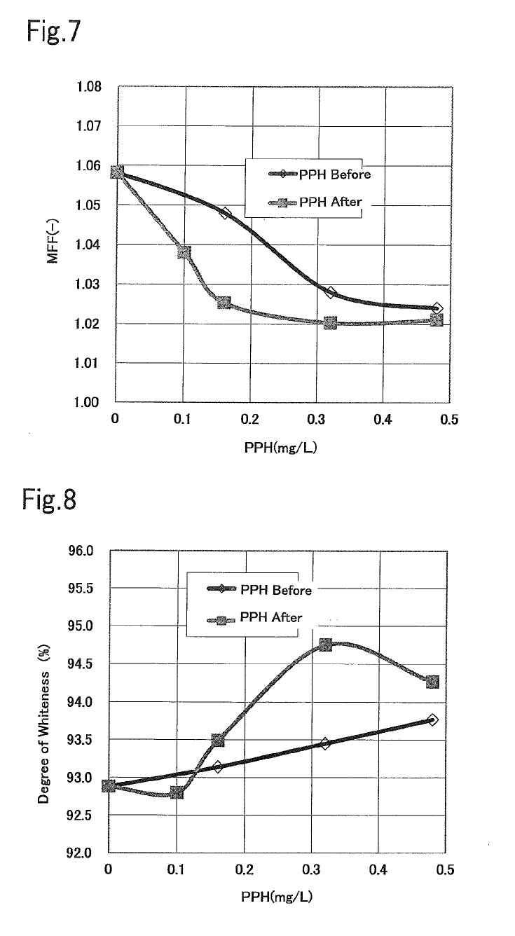

In addition, FIG. 7 shows the relationship between MFF and the addition amount of PPH obtained when the addition amount of ferric chloride is fixed constant to 0.33 mg/L as Fe and the addition amount of PPH is changed, and FIG. 8 shows the relationship between the addition amount of PPH and the degree of whiteness of the MF membrane.

In FIGS. 7 and 8, “PPH After” indicates the case of Example of the present invention in which PPH is added after the addition of ferric chloride, and “PPH Before” indicates the case of Comparative Example in which PPH is added before the addition of ferric chloride.

From FIGS. 7 and 8, it is found that the addition amount of PPH is preferably 0.15 to 0.4 mg/L and particularly preferably in a range of approximately 0.25 to 0.4 mg/L.

### Experiment IV

### Examples IV-1 to IV-8

After 3 mg/L of acetic acid was added to the seawater of Experiment III, and oxygen was sufficiently supplied therein by aeration for 1 hour, the seawater was left still at 20° C. to 25° C. for 5 days to propagate naturally occurring marine microorganisms, so that polluted seawater was prepared. This polluted seawater was used as water to be treated, and a test similar to that of Experiment III was performed.

The addition amount of ferric chloride and the type and the amount of the phenolic high molecular weight compound are as shown in Table 4. The measured MFF value, the estimated SDI value, and the degree of whiteness of the MF membrane are shown in Table 4.

### Comparative Examples IV-1 to IV-16

The contents of Comparative Examples are as described below.

Comparative Example IV-1: The coagulation treatment was not performed, the filtration treatment was only performed, and MMF and the degree of whiteness of the MF membrane were measured.
Comparative Examples IV-2 to IV-6: As the coagulant, ferric chloride was only used. The phenolic high molecular weight compound was not added. The other conditions were the same as those of Example.
Comparative Example IV-7: As the coagulant, the phenolic high molecular weight compound was only used. Ferric chloride was not added. The other conditions were the same as those of Example.
Comparative Examples IV-8 to IV-16: The phenolic high molecular weight compound was added first, and ferric chloride was added later. The other conditions were the same as those of Example.

The results are shown in Table 4.

TABLE 4

| | Addition Amount of | | Phenolic High | | | | | |
|---|---|---|---|---|---|---|---|---|
| | Ferric Chloride | | Molecular Weight | | | | | |
| | Amount of | | Compound | | | | | Degree of |
| | Product | Fe Element- | | Addition | | | | Whiteness of |
| | (38% FeCl₃) | Based Amount | | Amount | Order of | MFF | Estimated | MF Membrane |
| | (mg/L) | (mg/L) | Type | (mg/L) | Addition | Value | SDI Value | (%) |
| Comparative | — | — | — | — | — | 1.276 | >6.67 | 94.24 |
| Example IV-1 | | | | | | | | |
| Comparative | 2.5 | 0.33 | — | — | — | 1.137 | 5.25 | 92.02 |
| Example IV-2 | | | | | | | | |
| Comparative | 5.0 | 0.66 | — | — | — | 1.118 | 4.70 | 92.70 |
| Example IV-3 | | | | | | | | |
| Comparative | 8.0 | 1.05 | — | — | — | 1.105 | 4.33 | 92.48 |
| Example IV-4 | | | | | | | | |
| Comparative | 12.0 | 1.57 | — | — | — | 1.091 | 3.91 | 92.61 |
| Example IV-5 | | | | | | | | |
| Comparative | 20.0 | 2.62 | — | — | — | 1.088 | 3.83 | 92.95 |
| Example IV-6 | | | | | | | | |
| Comparative | — | — | PPH | 0.32 | — | 1.143 | 5.43 | 92.95 |
| Example IV-7 | | | | | | | | |
| Example IV-1 | 2.5 | 0.33 | PPH | 0.32 | After | 1.060 | 3.01 | 94.02 |
| Example IV-2 | 5.0 | 0.66 | PPH | 0.32 | After | 1.050 | 2.72 | 94.12 |
| Example IV-3 | 8.0 | 1.05 | PPH | 0.32 | After | 1.052 | 2.78 | 94.02 |
| Example IV-4 | 12.0 | 1.57 | PPH | 0.32 | After | 1.050 | 2.72 | 93.91 |
| Comparative | 2.5 | 0.33 | PPH | 0.32 | Before | 1.121 | 4.79 | 92.65 |
| Example IV-8 | | | | | | | | |
| Comparative | 5.0 | 0.66 | PPH | 0.32 | Before | 1.098 | 4.12 | 93.33 |
| Example IV-9 | | | | | | | | |
| Comparative | 8.0 | 1.05 | PPH | 0.32 | Before | 1.083 | 3.68 | 93.52 |
| Example IV-10 | | | | | | | | |
| Comparative | 12.0 | 1.57 | PPH | 0.32 | Before | 1.084 | 3.71 | 93.61 |
| Example IV-11 | | | | | | | | |
| Example IV-5 | 2.5 | 0.33 | PPH | 0.48 | After | 1.070 | 3.28 | 93.87 |
| Comparative | 2.5 | 0.33 | PPH | 0.48 | Before | 1.081 | 3.62 | 93.42 |
| Example IV-12 | | | | | | | | |
| Example IV-6 | 5.0 | 0.66 | PPH | 0.16 | After | 1.096 | 4.06 | 92.91 |
| Comparative | 5.0 | 0.66 | PPH | 0.16 | Before | 1.103 | 4.26 | 92.88 |
| Example IV-13 | | | | | | | | |
| Example IV-7 | 5.0 | 0.66 | PPH | 0.48 | After | 1.056 | 2.89 | 94.04 |
| Comparative | 5.0 | 0.66 | PPH | 0.48 | Before | 1.087 | 3.79 | 93.56 |
| Example IV-14 | | | | | | | | |
| Comparative | 5.0 | 0.66 | PPH | 0.60 | Before | 1.075 | 3.44 | 93.67 |
| Example IV-15 | | | | | | | | |
| Example IV-8 | 5.0 | 0.66 | PVPF | 0.32 | After | 1.049 | 2.68 | 94.23 |
| Comparative | 5.0 | 0.66 | PVPF | 0.32 | Before | 1.103 | 4.26 | 93.32 |
| Example IV-16 | | | | | | | | |

### DISCUSSION

As shown in Comparative Example IV-1, if the polluted seawater used in Experiment IV was not processed by a coagulation treatment with chemicals, the MFF value was 1.276, and the estimated SDI value was 6.67 or more which was beyond the measurable level; hence, this seawater could not be supplied to membrane filtration due to its inferior water quality. However, since ferric chloride was not added, fine colloids were not generated, and the degree of whiteness of the MF membrane was high.

As the case in which only ferric chloride was added, in Comparative Example IV-6 in which the addition amount was increased to 2.62 mg/L as Fe, although an MFF value of 1.088 and an estimated SDI value of 3.83 could be obtained, because of generation of fine colloids of iron hydroxides, the membrane fouling seriously occurred, and the degree of whiteness of the MF membrane was low.

In Comparative Example IV-7 in which 0.32 mg/L of PPH was added, although the MFF value was improved as compared to that of Comparative Example IV-1 in which no chemicals were added, the MFF value and the estimated SDI value were 1.143 and 5.43, respectively, and hence the effect was not sufficient.

In Examples IV-1 to IV-4 in each of which the addition amount of PPH was fixed to 0.32 mg/L, and the addition amount of ferric chloride was changed, preferable results could be obtained in each Example.

On the other hand, in Comparative Examples IV-8 to IV-11 in which although the same addition amounts of ferric chloride and PHP as those of Examples IV-1 to IV-4 were used, PPH was added first and ferric chloride was added later, the estimated SDI value and the degree of whiteness of the MF membrane were both inferior.

In Examples IV-5 to IV-7 and Comparative Examples IV-12 to IV-14, the addition of ferric chloride and the addition amount of PPH were variously changed, and the order of addition of each Comparative Example was set to be opposite to that of the corresponding Example. In every comparison between Comparative Example and Example, it is found that when ferric chloride is added first, and PPH is added later, a superior effect can be obtained.

In Comparative Example IV-15 in which large amounts of ferric chloride and PPH, such as 0.66 mg/L as Fe and 0.60 mg/L, respectively, were used, and PPH and ferric chloride were sequentially added in this order, the estimated SDI value was 3.44 which was inferior to an estimated SDI value of 3.01 of Example IV-1 in which 0.33 mg/L as Fe of ferric chloride and 0.32 mg/L of PPH were used, and ferric chloride and PPH were sequentially added in this order, and furthermore, the degree of whiteness of the MF membrane was also low.

In addition, in Example IV-8 and Comparative Example IV-16, the addition amount of PVPF functioning as the phenolic high molecular weight compound was set to be equal to each other, and the order of addition thereof was set to be opposite to each other. As a result, the estimated SDI value of Example IV-8 was 2.68 and was significantly improved from an estimated SDI value of 4.26 of Comparative Example IV-16. From the results described above, it is also found that when ferric chloride functioning as the inorganic coagulant is added before the addition of the phenolic high molecular weight compound, a high coagulation effect can be obtained.

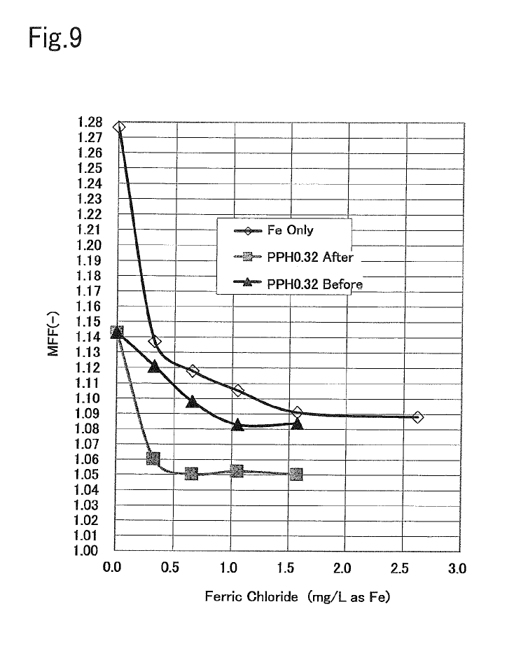

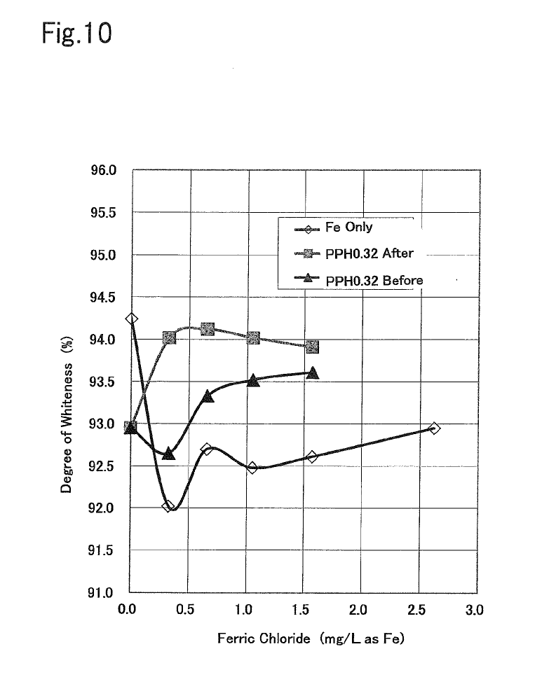

FIG. 9 shows the relationship between MFF and the addition amount of ferric chloride obtained when the addition amount of PPH is fixed constant to 0.32 mg/L and the addition amount of ferric chloride is changed, and the relationship between MFF and the addition amount of ferric chloride obtained when only ferric chloride is added, and FIG. 10 shows the relationship between the addition amount of ferric chloride and the degree of whiteness of the MF membrane.

In FIGS. 9 and 10, “PPH0.32 After” indicates the case of Example of the present invention in which 0.32 mg/L of PPH is added after the addition of ferric chloride, and “PPH0.32 Before” indicates the case of Comparative Example in which 0.32 mg/L of PPH is added before the addition of ferric chloride.

From FIGS. 9 and 10, it is found that in the present invention, the addition amount of ferric chloride is preferably 0.3 to 1.5 mg/L as Fe and particularly preferably in a range of approximately 0.5 to 1.0 mg/L as Fe.

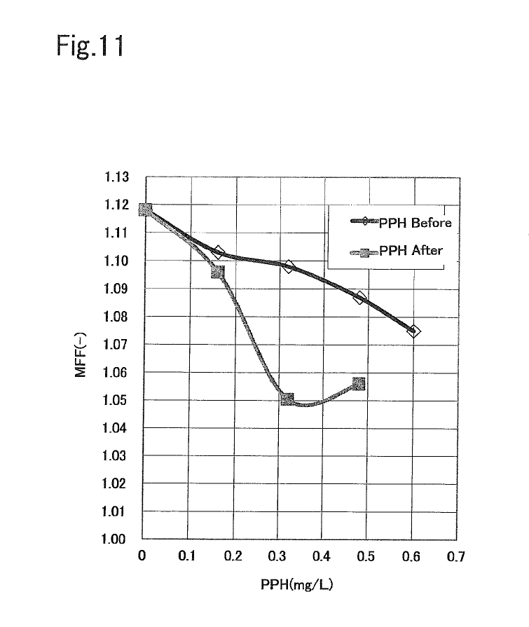

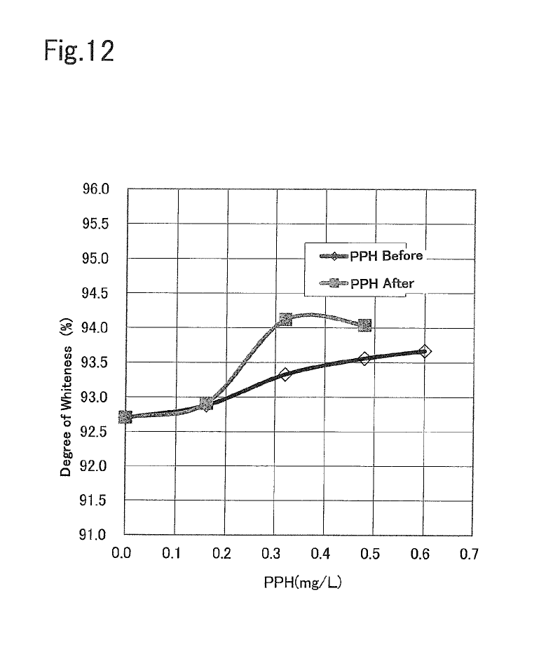

In addition, FIG. 11 shows the relationship between MFF and the addition amount of PPH obtained when the addition amount of ferric chloride is fixed constant to 0.66 mg/L as Fe and the addition amount of PPH is changed, and FIG. 12 shows the relationship between the addition amount of PPH, which is the same as described above, and the degree of whiteness of the MF membrane.

In FIGS. 11 and 12, “PPH After” indicates the case of Example of the present invention in which PPH is added after the addition of ferric chloride, and “PPH Before” indicates the case of Comparative Example in which PPH is added before the addition of ferric chloride.

From FIGS. 11 and 12, it is found that the addition amount of PPH is preferably 0.2 to 0.5 mg/L and particularly preferably in a range of approximately 0.25 to 0.45 mg/L.

Although the present invention has been described in details with reference to specific modes, it is apparent to a person skilled in the art that various modifications may be performed without departing from the sprit and the scope of the present invention.

In addition, this application claims the benefit of Japanese Patent Application No. 2011-287580, filed Dec. 28, 2011, which is hereby incorporated by reference herein in its entirety.

1. A seawater treatment method which is a pretreatment method performed prior to a membrane separation treatment of seawater, the method comprising:
adding a cationic organic flocculant and/or an inorganic coagulant to seawater to conduct a reaction;
then adding an alkaline solution of a high molecular weight compound which has a phenolic hydroxide and which is insolubilized under a high salt concentration to perform a coagulation treatment; and
then performing a solid-liquid separation treatment.

2. The seawater treatment method according to claim 1,
wherein an addition amount of the cationic organic flocculant to seawater is 0.25 mg/L or less as an effective component, and a resin-component addition amount of the alkaline solution of a high molecular weight compound which has a phenolic hydroxide and which is insolubilized under a high salt concentration is 1.3 times or more the addition amount of the cationic organic flocculant.

3. The seawater treatment method according to claim 1,
wherein the inorganic coagulant is an iron-based coagulant or an aluminum-based coagulant, an addition amount of the iron-based coagulant to seawater is 2.0 mg/L or less in the form of Fe, an addition amount of the aluminum-based coagulant is 5 mg/L or less in the form of Al₂O₃, and a resin-component addition amount of the alkaline solution of a high molecular weight compound which has a phenolic hydroxide and which is insolubilized under a high salt concentration is 0.1 to 1 mg/L.

4. A method for treating seawater comprising:
performing a reverse osmosis membrane treatment after the seawater treatment method according to claim 1 is performed.
